(19) United States
(12) Patent Application Publication
(10) Pub. No.: US 2026/0316888 A1
(43) Pub. Date: Oct. 15, 2026

(54) COMPONENT FOR HUMAN-POWERED VEHICLE

(71) Applicant: Shimano Inc., Osaka (JP)

(72) Inventors: Sota YAMAGUCHI, Osaka (JP); Masanori SAKAI, Osaka (JP)

(21) Appl. No.: 19/462,059

(22) Filed: Jan. 28, 2026

(30) Foreign Application Priority Data
Feb. 27, 2025 (JP) 2025-030734

(51) Int. Cl. B62M 11/14; B62J 45/20; B62M 11/18

(52) U.S. Cl. CPC B62M 11/145; B62J 45/20; B62M 11/18

(57) ABSTRACT

A component for a human-powered vehicle includes an input shaft having an input center axis, a rotation ratio shifting unit, and a transmission unit including a transmission input portion, a transmission output portion, and a transmission center axis differing from the input center axis and configured to shift a transmission ratio of rotational speed of the transmission output portion to rotational speed of the transmission input portion. The rotation ratio shifting unit includes an input rotational body connected to the input shaft and rotated about the input center axis, an output rotational body connected to the transmission unit and rotated about the transmission center axis, and a linking rotational body configured to shift a ratio of rotational speed of the output rotational body to rotational speed of the input rotational body an rotated about a linking center axis differing from the input center axis and the transmission center axis.

### CROSS-REFERENCE TO RELATED APPLICATIONS

This application claims priority to Japanese Patent Application No. 2025-030734, filed on Feb. 27, 2025. The entire disclosure of Japanese Patent Application No. 2025-030734 is hereby incorporated by reference.

### BACKGROUND

### Technical Field

The present disclosure relates to a component for a human-powered vehicle.

### Background Information

WO2017/052141A discloses an example of a component for a human-powered vehicle. The component disclosed in WO2017/052141A includes a transmission and a crank axle into which human driving force is input. The crank axle and the transmission are connected by a crank gear and an input gear. The crank gear is provided on an outer circumference of the crank axle. The input gear is coaxial with the transmission.

### SUMMARY

The number of teeth on the crank gear and the number of teeth on the input gear are set based on the transmission ratio of the transmission. The distance from the crank axle to the transmission is limited by the number of teeth on the crank gear and the number of teeth on the input gear. In WO2017/052141A, the crank axle and the transmission are connected by the gears. It has been determined that the distance from the crank axle to the transmission is also limited in a transmission mechanism that includes rotational bodies of pulleys instead of gears.

One objective of the present disclosure is to provide a component for a human-powered vehicle that increases the degree of freedom in the design of the human-powered vehicle component.

In accordance with a first aspect of the present disclosure, a component for a human-powered vehicle is provided. The component comprises an input shaft, a rotation ratio shifting unit and a transmission unit. The input shaft has a human driving force input thereto and has an input center axis, a rotation ratio shifting unit to which rotational force of the input shaft is transmitted. The transmission unit includes a transmission input portion to which rotational force from the rotation ratio shifting unit is input, a transmission output portion that externally outputs the rotational force input to the transmission input portion, and a transmission center axis differing from the input center axis. The transmission unit is configured to shift a transmission ratio that is a ratio of a rotational speed of the transmission output portion to a rotational speed of the transmission input portion. The rotation ratio shifting unit includes an input rotational body connected to the input shaft and rotated about the input center axis, an output rotational body connected to the transmission unit and rotated about the transmission center axis, and a linking rotational body that transmits rotational force of the input rotational body to the output rotational body. The rotation ratio shifting unit is configured to shift a ratio of a rotational speed of the output rotational body to a rotational speed of the input rotational body. The linking rotational body is rotated about a linking center axis differing from both the input center axis and the transmission center axis.

The component according to the first aspect includes a linking center axis differing from both the input center axis and the transmission center axis. Thus, the distance between the input center axis and the transmission center axis can be changed by adjustment of the position of the linking center axis. This increases the degree of freedom in the design of the component.

In accordance with a second aspect of the present disclosure, the component according to the first aspect is configured so that a final shifting ratio that is a ratio of a rotational speed of the output rotational body to a rotational speed of the input rotational body is greater than 1.0.

The component according to the second aspect increases the degree of freedom in the design of a component including a speed increaser.

In accordance with a third aspect of the present disclosure, the component according to the second aspect is configured so that the final shifting ratio is greater than 6.0.

The component according to the third aspect increases the degree of freedom in the design of a component having a final shifting ratio that is greater than 6.0.

In accordance with a fourth aspect of the present disclosure, the component according to any one of the first to third aspects is configured so that a first shifting ratio that is a ratio of a rotational speed of the linking rotational body to a rotational speed of the input rotational body is greater than 1.0.

The component according to the fourth aspect increases the degree of freedom in the design of a component having a first shifting ratio that is greater than 1.0.

In accordance with a fifth aspect of the present disclosure, the component according to any one of the first to fourth aspects is configured so that a second shifting ratio that is a ratio of a rotational speed of the output rotational body to a rotational speed of the linking rotational body is greater than 1.0.

The component according to the fifth aspect increases the degree of freedom in the design of a component having a second shifting ratio that is greater than 1.0.

In accordance with a sixth aspect of the present disclosure, the component according to the fourth aspect is configured so that a second shifting ratio that is a ratio of a rotational speed of the output rotational body to a rotational speed of the linking rotational body is greater than 1.0. The first shifting ratio is greater than the second shifting ratio.

In the component according to the sixth aspect, the first shifting ratio is greater than the second shifting ratio. This decreases rotational force of the linking rotational body.

In accordance with a seventh aspect of the present disclosure, the component according to any one of the first to sixth aspects is configured so that the input rotational body includes an input gear. The output rotational body includes an output gear. The linking rotational body includes a first linking gear meshed with the input gear and a second linking gear meshed with the output gear.

In the component according to the seventh aspect, the input gear, the first linking gear, the second linking gear, and the output gear form the rotation ratio shifting unit.

In accordance with an eighth aspect of the present disclosure, the component according to the seventh aspect is configured so that the first linking gear is formed integrally with the second linking gear.

In the component according to the eighth aspect, the first linking gear and the second linking gear are formed integrally, thereby reducing the number of components.

In accordance with a ninth aspect of the present disclosure, the component according to the seventh or eighth aspect is configured so that the first linking gear and the second linking gear have different numbers of teeth.

In the component according to the ninth aspect, the number of teeth differs between the first linking gear and the second linking gear. Thus, the ratio of rotational speed of the output rotational body to rotational speed of the input rotational body is appropriately changed.

In accordance with a tenth aspect of the present disclosure, the component according to any one of the first to ninth aspects is configured so that the input rotational body is separated from the output rotational body as viewed in an input axial direction aligned with the input center axis.

In the component according to the tenth aspect, as viewed in the input axial direction, the input rotational body is separated from the output rotational body. Thus, the input rotational body and the output rotational body are spaced apart from each other.

In accordance with an eleventh aspect of the present disclosure, the component according to any one of the first to tenth aspects is configured so that in a case where the input rotational body is rotated in one of a clockwise direction and a counterclockwise direction as viewed in an input axial direction aligned with the input center axis, the output rotational body is configured to be rotated in the one of the clockwise direction and the counterclockwise direction as viewed in the input axial direction.

In the component according to the eleventh aspect, the output rotational body rotates in the same direction as the input rotational body.

In accordance with a twelfth aspect of the present disclosure, the component according to any one of the first to eleventh aspects is configured so that the transmission unit includes at least one planetary gear mechanism.

In the component according to the twelfth aspect, the transmission unit including at least one planetary gear mechanism appropriately performs shifting.

In accordance with a thirteenth aspect of the present disclosure, the component according to any one of the first to twelfth aspects is configured so that the transmission unit further includes a first transmission unit including a first transmission input portion to which rotational force from the transmission input portion is transmitted, and a first transmission output portion to which rotational force from the first transmission input portion is transmitted, and a second transmission unit including a second transmission input portion to which rotational force from the first transmission output portion is transmitted, and a second transmission output portion to which rotational force from the second transmission input portion is transmitted. The first transmission unit is configured to select a ratio of a rotational speed of the first transmission output portion to a rotational speed of the first transmission input portion from multiple first transmission ratios. The second transmission unit is configured to select a ratio of a rotational speed of the second transmission output portion to a rotational speed of the second transmission input portion from multiple second transmission ratios.

In the component according to the thirteenth aspect, the first transmission unit, which includes the first transmission input portion and the first transmission output portion, appropriately obtains multiple first transmission ratios. In the component according to the thirteenth aspect, the second transmission unit, which includes the second transmission input portion and the second transmission output portion, appropriately obtains multiple second transmission ratios.

In accordance with a fourteenth aspect of the present disclosure, the component according to the thirteenth aspect is configured so that the first transmission unit includes a first planetary gear unit. The first planetary gear unit includes a first planet gear, a first carrier supporting the first planet gear, a first sun gear meshed with the first planet gear, and a first ring gear meshed with the first planet gear. A rotational state of at least one of the first sun gear, the first carrier, and the first ring gear is controlled to select one of the first transmission ratios. The second transmission unit includes a second planetary gear unit. The second planetary gear unit includes a second planet gear, a second carrier supporting the second planet gear, a second sun gear meshed with the second planet gear, and a second ring gear meshed with the second planet gear. A rotational state of at least one of the second sun gear, the second carrier, and the second ring gear is controlled to select one of the second transmission ratios.

The component according to the fourteenth aspect controls the rotational state of one of the first sun gear, the first carrier, and the first ring gear so that the first transmission unit selects one of the first transmission ratios in a preferred manner. The component according to the tenth aspect controls the rotational state of one of the second sun gear, the second carrier, and the second ring gear so that the second transmission unit selects one of the second transmission ratios in a preferred manner.

In accordance with a fifteenth aspect of the present disclosure, the component according to the fourteenth aspect further comprises a transmission controller configured to control the transmission unit. The transmission controller is configured to control the rotational state of the first ring gear and the rotational state of the second ring gear.

In the component according to the fifteenth aspect, the transmission controller controls the rotational state of the first ring gear and the rotational state of the second ring gear to appropriately perform shifting.

In accordance with a sixteenth aspect of the present disclosure, in the component according to the fourteenth or fifteenth aspect, the output rotational body is configured to be connected to the transmission unit by a coupling portion coupling the output rotational body and the first carrier.

In the component according to the sixteenth aspect, the coupling portion connects the output rotational body and the first carrier so that rotational force is transmitted from the output rotational body to the first carrier in a preferred manner.

In accordance with a seventeenth aspect of the present disclosure, the component according to any one of the first to sixteenth aspects is configured so that the input shaft is a crank axle of the human-powered vehicle.

With the component according to the seventeenth aspect, shifting is appropriately performed on human driving force input to the crank axle.

In accordance with an eighteenth aspect of the present disclosure, the component according to any one of the first to seventeenth aspects further comprises an output that outputs rotational force of the transmission output portion. The output has an output center axis differing from the input center axis.

With the component according to the eighteenth aspect, the output has the output center axis differing the input center axis. This allows the output and the input shaft to be arranged at different positions.

In accordance with a nineteenth aspect of the present disclosure, the component according to the eighteenth aspect is configured so that the output center axis is concentric with the transmission center axis.

With the component according to the nineteenth aspect, the output center axis is concentric with the transmission center axis. This limits enlargement of the component in the radial direction of the output center axis.

In accordance with a twentieth aspect of the present disclosure, the component according to any one of the first to nineteenth aspects further comprises a housing including an interior space. The rotation ratio shifting unit and the transmission unit are arranged in the interior space.

In the component according to the twentieth aspect, the rotation ratio shifting unit and the transmission unit are arranged in the interior space. Thus, the rotation ratio shifting unit and the transmission unit are protected.

The component for a human-powered vehicle according to the present disclosure increases the degree of freedom in the design of a component for a human-powered vehicle.

### BRIEF DESCRIPTION OF THE DRAWINGS

FIG. 1 is a side view of a drive mechanism for a human-powered vehicle including a human-powered vehicle component in accordance with an embodiment.

FIG. 2 is a perspective view of the human-powered vehicle component shown in FIG. 1.

FIG. 3 is a plan view of the human-powered vehicle component shown in FIG. 1.

FIG. 4 is a side view of the human-powered vehicle component shown in FIG. 1, without a second housing.

FIG. 5 is a side view of the human-powered vehicle component shown in FIG. 1, without a first housing, viewed in the direction opposite to FIG. 4.

FIG. 6 is a perspective view of the human-powered vehicle component shown in FIG. 1, including the first housing and a member coupled to the first housing.

FIG. 7 is a perspective view of the human-powered vehicle component shown in FIG. 1, including the second housing and a member coupled to the second housing.

FIG. 8 is a plan view of the human-powered vehicle component shown in FIG. 1, including members accommodated in the housing.

FIG. 9 is a cross-sectional view of the human-powered vehicle component taken along line D9-D9 in FIG. 5.

FIG. 10 is an enlarged cross-sectional view of a rotation ratio shifting unit shown in FIG. 9 and its surroundings.

FIG. 11 is a perspective view of a support shown in FIG. 6.

FIG. 12 is an enlarged cross-sectional view of a transmission unit shown in FIG. 9 and its surroundings.

FIG. 13 is a skeleton diagram showing a transmission path of driving power of the human-powered vehicle component shown in FIG. 1.

FIG. 14 is a schematic diagram showing a first modified example of a human-powered vehicle component.

FIG. 15 is a side view of a drive mechanism for a human-powered vehicle including a second modified example of a human-powered vehicle component.

FIG. 16 is a schematic diagram showing a third modified example of a human-powered vehicle component.

FIG. 17 is a schematic diagram showing a fourth modified example of a human-powered vehicle component.

### DETAILED DESCRIPTION

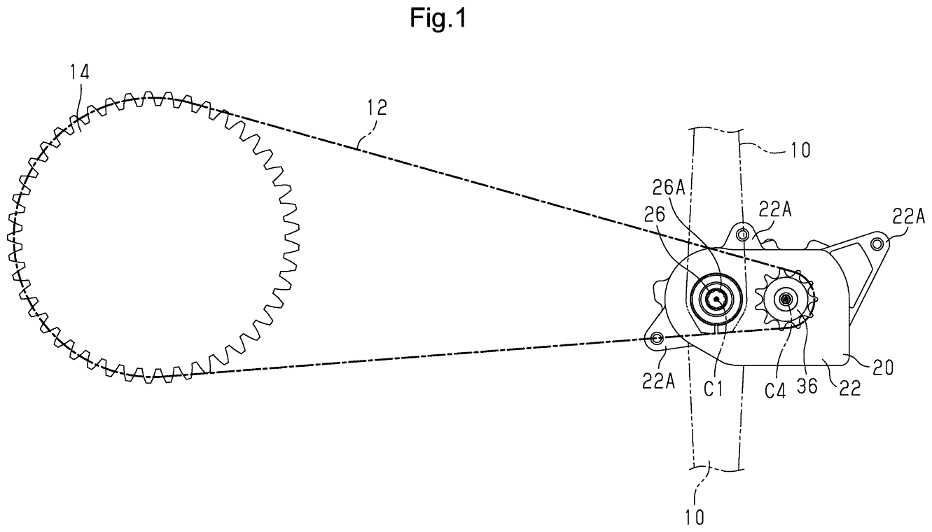

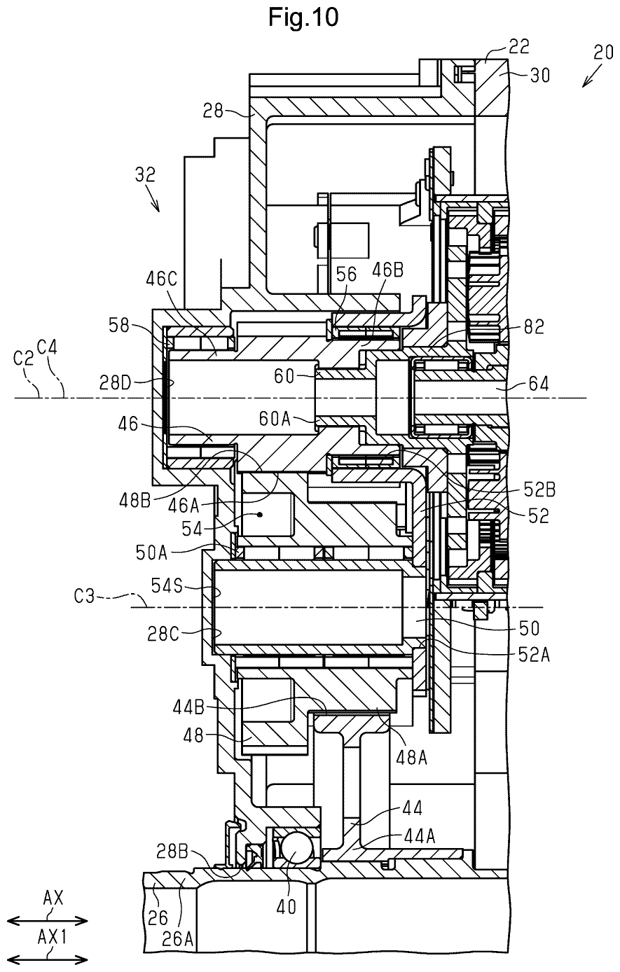

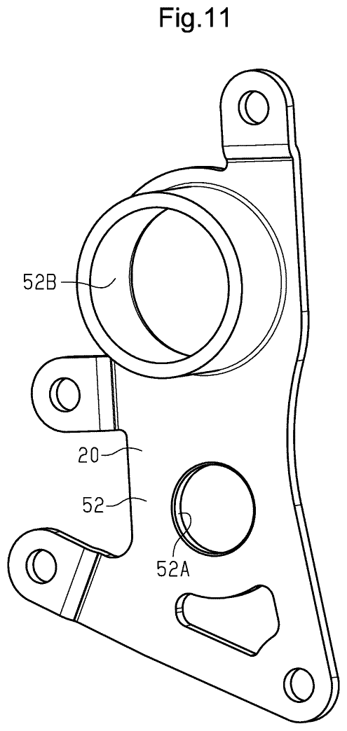

On embodiment of a component 20 for a human-powered vehicle will now be described with reference to FIGS. 1 to 13. The human-powered vehicle is a vehicle including at least one wheel and driven by at least a human driving force. The human-powered vehicle includes, for example, various types of bicycles such as a mountain bike, a road bike, a city bike, a cargo bike, a hand bike, and a recumbent bike. The number of wheels on the human-powered vehicle is not limited. The human-powered vehicle includes, for example, a unicycle and a vehicle including two or more wheels. The human-powered vehicle is not limited to a vehicle configured to be driven only by a human driving force. The human-powered vehicle includes an E-bike that uses the driving force of an electric motor in addition to a human driving force for propulsion. The E-bike includes an electric assist bicycle that assists in the propulsion with an electric motor. In the embodiments described below, the human-powered vehicle refers to a bicycle.

The human-powered vehicle includes, for example, a vehicle body and a wheel. The vehicle body includes, for example, a frame. The wheel is, for example, provided on the frame. The wheel can be at least one wheel that includes a front wheel and a rear wheel. The human-powered vehicle includes an input shaft 26 that is rotatable relative to the frame. A crank arm 10 is provided on each end of the input shaft 26 in an axial direction AX. A pedal is coupled to each crank arm 10. A human driving force can be input to the input shaft 26 from the crank arms 10 and the pedals.

As shown in FIG. 1, the human-powered vehicle includes the component 20. The component 20 is, for example, provided on a transmission path of human driving force between the input shaft 26 and a driving wheel of the human-powered vehicle. The driving wheel includes, for example, at least one of the front wheel and the rear wheel. The driving wheel includes, for example, the rear wheel. The component 20 is arranged around an input center axis C1 of the input shaft 26. The component 20 can be provided on an axle of the driving wheel. The component 20 is coupled to the frame.

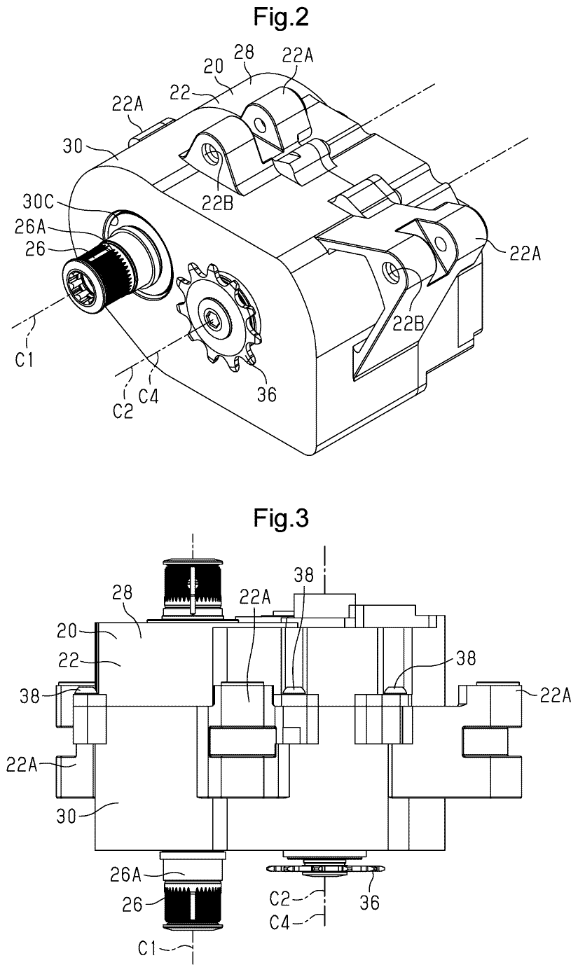

As shown in FIGS. 2 to 7, the component 20 further includes, for example, a housing 22. The housing 22 includes, for example, an interior space 24. The housing 22 includes a first housing 28 and a second housing 30.

The component 20 includes, for example, the input shaft 26, the first housing 28, the second housing 30, a rotation ratio shifting unit 32, and a transmission unit 34. In an example, the rotation ratio shifting unit 32 and the transmission unit 34 are arranged in the interior space 24 of the component 20. In an example, at least part of the rotation ratio shifting unit 32 can be provided in the first housing 28. In an example, at least part of the transmission unit 34 can be provided in the second housing 30.

The component 20 further includes, for example, an output 36. The output 36 includes, for example, at least one of a sprocket, a pulley, and a bevel gear. The output 36 is, for example, provided outside of the interior space 24 of the component 20. The output 36 is, for example, provided in the second housing 30. The output 36 is, for example, configured to engage a linking body 12 to which a human driving force is transmitted from the output 36. The linking body 12 includes, for example, at least one of a chain, a belt, and a shaft. The output 36 transmits the driving force to the rear wheel, for example, through a sprocket and a chain. The output 36 is, for example, connected to a rotational body 14 of the driving wheel by the linking body 12.

The output 36 is, for example, configured to the transmit driving force to the driving wheel through the linking body 12. In a state where the housing 22 is coupled to the frame, driving force output from the component 20 is transmitted to the driving wheel of the human-powered vehicle through the linking body 12.

In the transmission path of human driving force, a first one-way clutch can be provided between the input shaft 26 and the output 36. The first one-way clutch includes, for example, at least one of a roller clutch, a pawl-type clutch, and a sprag-type clutch. In an example, the first one-way clutch allows forward rotation of the output 36 in a case where the input shaft 26 rotates forward. In an example, the first one-way clutch restricts backward rotation of the output 36 in a case where the input shaft 26 rotates backward. The direction in which the input shaft 26 rotates forward corresponds to, for example, a rotational direction of the input shaft 26 in which the human-powered vehicle travels forward. The direction in which the input shaft 26 rotates forward corresponds to, for example, a rotational direction of the rotational body 14 in a case where the human-powered vehicle travels forward.

As shown in FIGS. 2 and 3, the housing 22 includes, for example, a housing protrusion 22A. The housing protrusion 22A protrudes, for example, in a direction intersecting the input center axis C1 of the input shaft 26. The housing 22 includes, for example, multiple housing protrusions 22A. In the present embodiment, the number of housing protrusions 22A is three. The housing protrusions 22A are, for example, provided so as to surround the input center axis C1 of the input shaft 26. The component 20 further includes, for example, a frame fastening member. The housing protrusions 22A each have, for example, a frame coupling hole 22B. The frame fastening member connects, for example, the frame coupling hole 22B and a hole in the frame. The component 20 is coupled to the frame by the frame fastening member. In the present embodiment, the housing protrusions 22A and the frame coupling holes 22B are, for example, provided in the second housing 30.

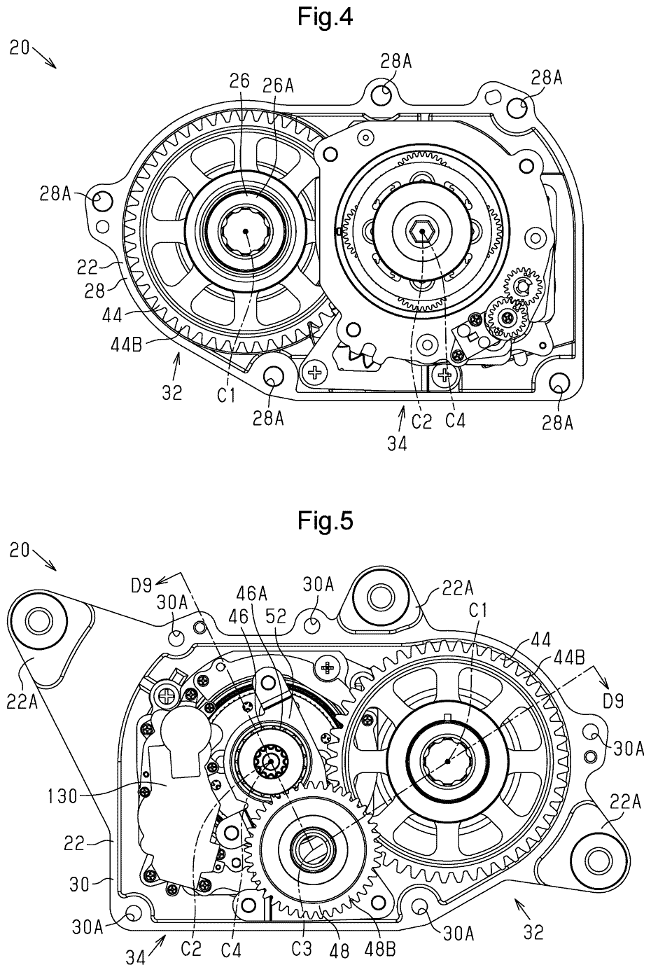

As shown in FIGS. 4 to 7, the second housing 30 is, for example, separate from the first housing 28. In an example, the second housing 30 is coupled to the first housing 28. In an example, the second housing 30 is coupled to the first housing 28 in a removable manner. In an example, the second housing 30 is coupled to the first housing 28 in a manner contacting the first housing 28. The second housing 30 can be provided in indirect contact with the first housing 28. In a case where the second housing 30 is provided in indirect contact with the first housing 28, a spacer or a sealing member can be provided between the second housing 30 and the first housing 28. In a case where the spacer or the sealing member is into contact with the first housing 28 and the second housing 30, the first housing 28 and the second housing 30 are in indirect contact with each other via the spacer or the sealing member.

The first housing 28 includes, for example, a first coupling portion 28A. The second housing 30 includes, for example, a second coupling portion 30A. The component 20 further includes, for example, a housing fastening member 38. The housing fastening member 38 connects the first housing 28 and the second housing 30 via the first coupling portion 28A and the second coupling portion 30A. The housing fastening member 38 includes, for example, a bolt. In an example, one of the first coupling portion 28A and the second coupling portion 30A includes a through hole, and the other of the first coupling portion 28A and the second coupling portion 30A includes an internal thread. Alternatively, in a case where the first coupling portion 28A and the second coupling portion 30A each include a through hole, the housing fastening member 38 can include a bolt and a nut. The first housing 28 can be coupled to the second housing 30 by, for example, press-fitting, welding, or an adhesive.

With reference to FIGS. 2 to 7, for example, a human driving force can be input to the input shaft 26. The input shaft 26 has, for example, the input center axis C1. The input shaft 26 is, for example, a crank axle 26A of a human-powered vehicle. The first housing 28 has, for example, a first input shaft coupling hole 28B. The second housing 30 includes, for example, a second input shaft coupling hole 30B. The input shaft 26 extends through the first housing 28, the interior space 24 of the housing 22, and the second housing 30.

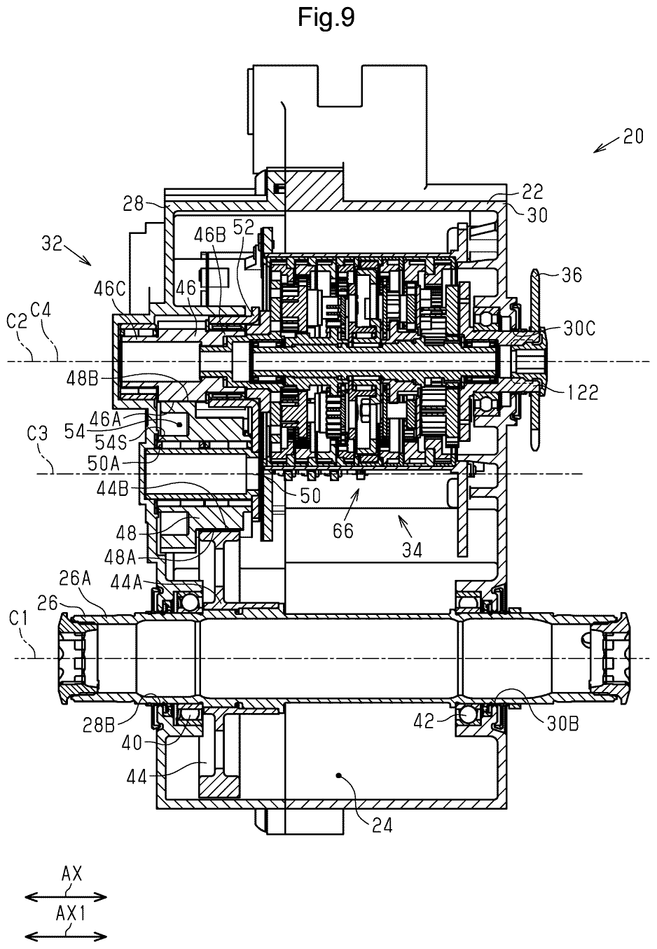

As shown in FIG. 9, the component 20 further includes, for example, a first input shaft bearing 40 and a second input shaft bearing 42. The first input shaft bearing 40 is, for example, provided in the first housing 28. The first input shaft bearing 40 supports, for example, the input shaft 26 so that the input shaft 26 is rotatable relative to the first housing 28. The first input shaft bearing 40 includes, for example, a rolling-element bearing. The first input shaft bearing 40 can include a plain bearing. The first input shaft bearing 40 is, for example, provided in the first input shaft coupling hole 28B in the first housing 28. In a case where the first input shaft bearing 40 includes a rolling-element bearing, for example, the outer race of the rolling-element bearing is press-fitted into the first input shaft coupling hole 28B. The second input shaft bearing 42 is, for example, provided in the second housing 30. The second input shaft bearing 42 supports, for example, the input shaft 26 so that the input shaft 26 is rotatable relative to the second housing 30. The second input shaft bearing 42 includes, for example, a rolling-element bearing. The second input shaft bearing 42 can include a plain bearing. The second input shaft bearing 42 is, for example, provided in the second input shaft coupling hole 30B in the second housing 30. In a case where the second input shaft bearing 42 includes a rolling-element bearing, for example, the outer race of the rolling-element bearing is press-fitted into the second input shaft coupling hole 30B.

The rotation ratio shifting unit 32, which is shown in FIGS. 5, 6, 9, and 10, is, for example, provided on a transmission path of human driving force. The rotation ratio shifting unit 32 is, for example, configured to shift the ratio of rotational speed of an output rotational body 46 to the rotational speed of an input rotational body 44. The rotation ratio shifting unit 32 includes, for example, the input rotational body 44, the output rotational body 46, and a linking rotational body 48. In an example, the rotational force of the input shaft 26 is transmitted to the rotation ratio shifting unit 32. The input rotational body 44 is, for example, connected to the input shaft 26. The input rotational body 44 includes a connector 44A connecting the input rotational body 44 to the input shaft 26. The connector 44A is, for example, provided with a spline. The input rotational body 44 is, for example, engaged with the input shaft 26 by the spline. The input rotational body 44 can be, for example, engaged with the input shaft 26 by press-fitting of the input shaft 26. Alternatively, the input rotational body 44 can be, for example, formed integrally with the input shaft 26. The input rotational body 44 is, for example, rotated about the input center axis C1 of the input shaft 26. The input rotational body 44 includes, for example, an input gear 44B.

The input rotational body 44 is, for example, separated from the output rotational body 46 as viewed in an input axial direction AX1 aligned with the input center axis C1. The input axial direction AX1 coincides with, for example, the axial direction AX. The input rotational body 44 is, for example, spaced apart from the output rotational body 46 as viewed in an input axial direction AX1 aligned with the input center axis C1.

In a case where the input rotational body 44 is rotated in one of a clockwise direction and a counterclockwise direction as viewed in the input axial direction AX1 aligned with the input center axis C1, the output rotational body 46 is, for example, configured to be rotated in the one of the clockwise direction and the counterclockwise direction as viewed in the input axial direction AX1. The input rotational body 44 is, for example, configured to be rotated in the same direction as the output rotational body 46. For example, in a case where the input rotational body 44 is rotated in the clockwise direction as viewed in the input axial direction AX1, the output rotational body 46 is configured to be rotated in the clockwise direction as viewed in the input axial direction AX1. For example, in a case where the input rotational body 44 is rotated in the counterclockwise direction as viewed in the input axial direction AX1, the output rotational body 46 is configured to be rotated in the counterclockwise direction as viewed in the input axial direction AX1.

The output rotational body 46 is, for example, connected to the transmission unit 34. The output rotational body 46 is, for example, rotated about a transmission center axis C2 of the transmission unit 34. The output rotational body 46 includes, for example, an output gear 46A. The output rotational body 46 includes, for example, a first end 46B and a second end 46C in the axial direction AX aligned with the transmission center axis C2. The first end 46B and the second end 46C extend in the axial direction AX aligned with the transmission center axis C2. The first end 46B is, for example, located at the second housing 30 in the axial direction AX. The second end 46C is, for example, located at the first housing 28 in the axial direction AX.

The linking rotational body 48 transmits, for example, rotational force of the input rotational body 44 to the output rotational body 46. The linking rotational body 48 is, for example, rotated about a linking center axis C3 differing from the input center axis C1 and the transmission center axis C2. The linking center axis C3 is, for example, substantially parallel to the input center axis C1. In the present embodiment, the phase “substantially parallel” refers to, for example, as being completely parallel and as being considered to be completely parallel. The case of as being considered to be completely parallel refers to, for example, a case where the non-parallel state has only a negligible effect on the function of the component 20.

The component 20 includes, for example, a linking rotational shaft 50. The linking rotational shaft 50 has the linking center axis C3. The linking rotational shaft 50 supports, for example, the linking rotational body 48. The linking rotational shaft 50 is, for example, formed separately from the linking rotational body 48. The linking rotational shaft 50 is, for example, coupled to the first housing 28 so as not to rotate relative to the first housing 28. The linking rotational body 48 is, for example, coupled to the linking rotational body 48 so as to be rotated about the linking rotational shaft 50. The linking rotational shaft 50 supports, for example, the linking rotational body 48 via a linking rotational body bearing 50A. The linking rotational body bearing 50A can be a plain bearing or can be a rolling-element bearing. The linking rotational shaft 50 can be integrated with the linking rotational body 48. In a case where the linking rotational shaft 50 is integrated with the linking rotational body 48, the linking rotational shaft 50 is coupled to the first housing 28 so as to be rotatable relative to the first housing 28.

The linking rotational body 48 includes, for example, a first linking gear 48A meshed with the input gear 44B and a second linking gear 48B meshed with the output gear 46A. The first linking gear 48A is, for example, formed integrally with the second linking gear 48B. The first linking gear 48A and the second linking gear 48B form, for example, a stepped gear. The first linking gear 48A and the second linking gear 48B can be formed separately. The number of teeth of the first linking gear 48A, for example, differs from the number of teeth of the second linking gear 48B. In an example, the number of teeth of the first linking gear 48A is less than the number of teeth of the second linking gear 48B.

As shown in FIGS. 5, 6, 10, and 11, the component 20 further includes, for example, a support 52. The support 52 is, for example, coupled to the first housing 28. In an example, the support 52 is coupled to the first housing 28 by bolts or the like. The support 52 supports, for example, the linking rotational body 48. In an example, the support 52 supports the linking rotational body 48 so that the linking rotational body 48 is rotatable relative to the first housing 28. The support 52 includes, for example, a linking rotational body support 52A. The linking rotational body support 52A has, for example, a hole configured to receive an end of the linking rotational shaft 50. In an example, the end of the linking rotational shaft 50 located at the second housing 30 is inserted into the hole of the linking rotational body support 52A. In an example, the first housing 28 includes a linking recess 28C receiving the end of the linking rotational shaft 50 located at the first housing 28. The support 52 supports, for example, the linking rotational body 48 with the linking rotational shaft 50.

The first housing 28 and the support 52 define, for example, an accommodation space 54. The accommodation space 54 is, for example, a cavity in an accommodation compartment 54S. The accommodation compartment 54S is, for example, defined by an inner surface of the first housing 28 and a surface of the support 52 located at the first housing 28. At least part of the linking rotational body 48 is, for example, arranged in the accommodation space 54. In the present embodiment, at least part of the linking rotational body 48 and at least part of the output rotational body 46 are arranged in the accommodation space 54.

The component 20 further includes, for example, a first output rotational body bearing 56 rotatably supporting the first end 46B of the output rotational body 46. The first output rotational body bearing 56 is, for example, provided on the support 52. The first output rotational body bearing 56 can be a plain bearing or can be a rolling-element bearing. The first housing 28 includes, for example, an output recess 28D receiving the second end 46C of the output rotational body 46 located at the first housing 28. The support 52 includes, for example, an output rotational body support 52B. The output rotational body support 52B has, for example, a hole. The first output rotational body bearing 56 is, for example, provided in the hole of the output rotational body support 52B. The component 20 further includes, for example, a second output rotational body bearing 58 rotatably supporting the second end 46C of the output rotational body 46. The second output rotational body bearing 58 is, for example, provided in the first housing 28. The second output rotational body bearing 58 can be a plain bearing or can be a rolling-element bearing. The second output rotational body bearing 58 is, for example, provided in the output recess 28D.

A first shifting ratio is a ratio of rotational speed of the linking rotational body 48 to rotational speed of the input rotational body 44 and is, for example, greater than 1.0. The first shifting ratio is, for example, greater than 2.0. The first shifting ratio is, for example, greater than 2.5. The first shifting ratio is, for example, 2.882. A second shifting ratio is a ratio of rotational speed of the output rotational body 46 to rotational speed of the linking rotational body 48 and is, for example, greater than 1.0. The second shifting ratio is, for example, greater than 1.5. The second shifting ratio is, for example, greater than 2.0. The second shifting ratio is, for example, 2.158. The first shifting ratio is, for example, greater than the second shifting ratio. A final shifting ratio is a ratio of rotational speed of the output rotational body 46 to rotational speed of the input rotational body 44 and is, for example, greater than 1.0. The final shifting ratio is calculated by, for example, multiplying the first shifting ratio and the second shifting ratio. The final shifting ratio is, for example, greater than 3.0. The final shifting ratio is, for example, greater than 5.0. The final shifting ratio is, for example, greater than 6.0. The final shifting ratio is, for example, 6.220.

The transmission unit 34, which is shown in FIGS. 4, 7, and 9 to 12, is, for example, provided on the transmission path of human driving force. The transmission unit 34 includes, for example, a transmission input portion 60, a transmission output portion 62, the transmission center axis C2, and a shaft member 64. The transmission center axis C2, for example, differs from the input center axis C1. The transmission center axis C2 is, for example, substantially parallel to the input center axis C1. The shaft member 64 is, for example, configured to be rotated about the transmission center axis C2.

In an example, the rotational force is input from the rotation ratio shifting unit 32 to the transmission input portion 60. The transmission unit 34 is, for example, configured to shift a transmission ratio that is a ratio of rotational speed of the transmission output portion 62 to rotational speed of the transmission input portion 60. The transmission unit 34 includes, for example, a transmission unit housing 34A accommodating at least part of the transmission unit 34. The transmission unit housing 34A is, for example, provided in the second housing 30.

The transmission input portion 60 is, for example, provided in the second housing 30. The transmission input portion 60 is, for example, coupled to the output rotational body 46 so as to be movable relative to the output rotational body 46 in the axial direction AX. The output rotational body 46 is, for example, configured to connect the output rotational body 46 and the transmission input portion 60. The component 20 further includes, for example, a coupling portion 60A. The coupling portion 60A can be formed integrally with or separately from the output rotational body 46. The coupling portion 60A can be formed integrally with or separately from the transmission input portion 60. In the present embodiment, the coupling portion 60A is integrated with the transmission input portion 60. The output rotational body 46 includes, for example, a gear or a spline. The transmission input portion 60 includes for example, a gear or a spline connected to the output rotational body 46.

The transmission output portion 62 outputs, for example, the rotational force received from the transmission input portion 60 to an external member. The transmission output portion 62 is, for example, configured to be connected to the output 36. The transmission output portion 62 includes, for example, a gear or a spline connected to the output 36. The transmission output portion 62 is, for example, supported by the second housing 30 in a manner rotatable relative to the second housing 30. The transmission output portion 62 is, for example, supported by the second housing 30 with a transmission output portion bearing 62A. The transmission output portion bearing 62A is, for example, arranged in an output hole 30C of the second housing 30. At least part of the transmission output portion 62 is, for example, arranged outside the housing 22. The output 36 outputs, for example, rotational force of the transmission output portion 62. The output 36 includes, for example, an output center axis C4 differing from the input center axis C1. The output center axis C4 is, for example, concentric with the transmission center axis C2. The output 36 is, for example, configured to rotate concentrically with the transmission center axis C2. The output 36 is, for example, provided on the transmission path of human driving force.

The transmission unit 34 includes, for example, at least one planetary gear mechanism 66. The transmission unit 34 allows for, for example, shifting to different transmission ratios. The transmission unit 34 is configured to, for example, select one from multiple transmission ratios. At least one of the transmission ratios can be greater than 1.0 or less than 1.0. At least one of the transmission ratios can be 1.0.

The transmission unit 34 further includes, for example, a first transmission unit 68 and a second transmission unit 70. The first transmission unit 68 and the second transmission unit 70 are, for example, arranged on the shaft member 64. The transmission unit housing 34A accommodates, for example, at least part of the first transmission unit 68 and at least part of the second transmission unit 70.

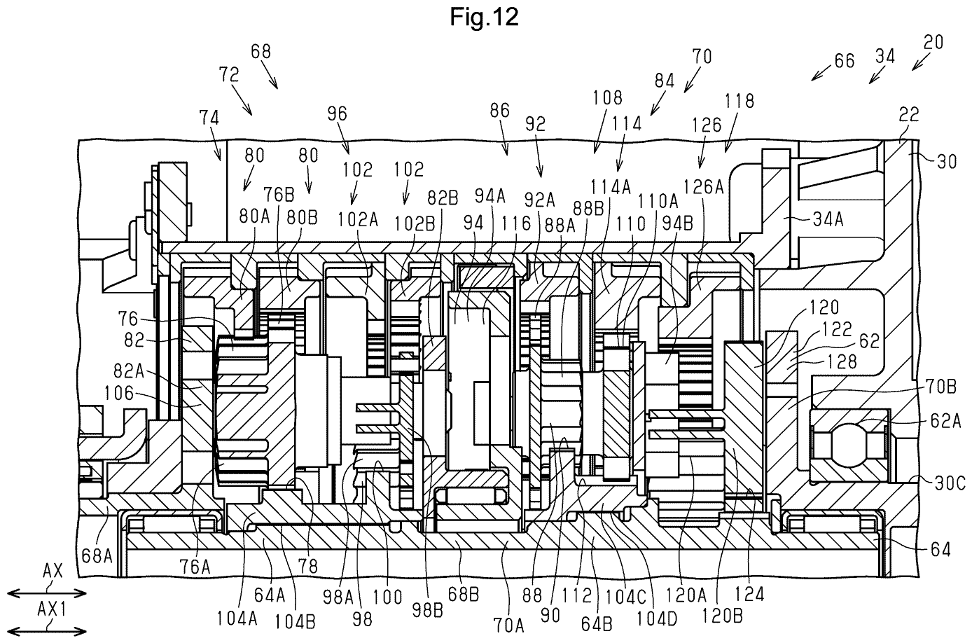

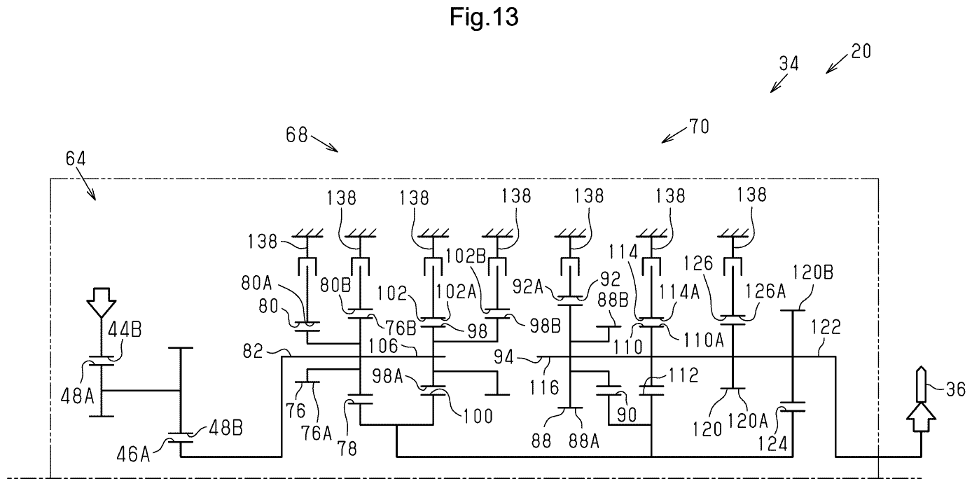

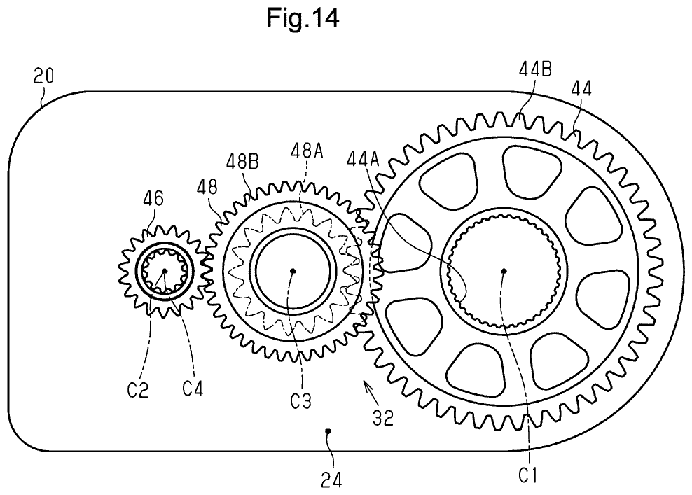

As shown FIGS. 12 and 13, the first transmission unit 68 includes, for example, a first transmission input portion 68A and a first transmission output portion 68B. In an example, the first transmission input portion 68A receives rotational force transmitted from the transmission input portion 60. In an example, the first transmission output portion 68B receives rotational force transmitted from the first transmission input portion 68A. The first transmission output portion 68B includes, for example, the shaft member 64. The first transmission unit 68 is, for example, configured to select a ratio of rotational speed of the first transmission output portion 68B to rotational speed of the first transmission input portion 68A from multiple first transmission ratios. Each of the first transmission ratios is, for example, 1.0 or greater. The first transmission ratios are configured so that the rotational speed of the first transmission output portion 68B is equal to or is increased from the rotational speed of the first transmission input portion 68A.

The second transmission unit 70 includes, for example, a second transmission input portion 70A and a second transmission output portion 70B. In an example, the second transmission input portion 70A receives rotational force transmitted from the first transmission output portion 68B. In an example, the second transmission output portion 70B receives rotational force transmitted from the second transmission input portion 70A. The second transmission input portion 70A includes, for example, the shaft member 64. The second transmission unit 70 is, for example, configured to select a ratio of rotational speed of the second transmission output portion 70B to rotational speed of the second transmission input portion 70A from multiple second transmission ratios. Each of the second transmission ratios is, for example, 1.0 or less. The second transmission ratios are configured so that the rotational speed of the second transmission output portion 70B is equal to or is decreased from the rotational speed of the second transmission input portion 70A.

The different transmission ratios are, for example, each determined by a combination of one selected from the first transmission ratios and one selected from the second transmission ratios. For example, the first transmission ratios are greater in number than the second transmission ratios.

The first transmission unit 68 includes, for example, multiple first planetary gear mechanisms 72. In an example, the first transmission ratios respectively correspond to the first planetary gear mechanisms 72.

The first transmission unit 68 includes, for example, a first planetary gear unit 74. The first planetary gear unit 74 includes, for example, a first planet gear 76, a first sun gear 78 meshed with the first planet gear 76, and a first ring gear 80 meshed with the first planet gear 76.

The first planet gear 76 is, for example, one of multiple first planet gears 76. The first planet gears 76 are, for example, arranged about the transmission center axis C2 of the shaft member 64 and are spaced apart from each other. The number of first planet gears 76 is, for example, 2 or greater and 8 or less. The number of first planet gears 76 is, for example, 4.

The first planet gears 76 include, for example, a first transmission planet gear 76A and a second transmission planet gear 76B having a larger pitch circle diameter than the first transmission planet gear 76A. The first transmission planet gear 76A and the second transmission planet gear 76B are, for example, formed integrally with each other. The first transmission planet gear 76A and the second transmission planet gear 76B can be formed separately and configured to rotate integrally with each other.

The first sun gear 78 can be one of multiple first sun gears 78. The first sun gear 78, for example, meshes with the second transmission planet gear 76B. The rotational center axis of the first sun gear 78 is substantially the same as the transmission center axis C2 of the shaft member 64.

The first ring gear 80 is, for example, one of a plurality of first ring gears 80. The first ring gears 80 are, for example, rotatable independently from one another. The first ring gears 80 include, for example, a first transmission ring gear 80A and a second transmission ring gear 80B. The first transmission ring gear 80A is meshed with, for example, the first transmission planet gear 76A. The second transmission ring gear 80B is meshed with, for example, the second transmission planet gear 76B.

The first planetary gear unit 74 includes, for example, a first carrier 82 that supports the first planet gear 76. The first carrier 82 includes, for example, a first carrier portion 82A and a second carrier portion 82B. The first carrier portion 82A is formed integrally with the first transmission input portion 68A. The output rotational body 46 is, for example, configured to be connected to by the coupling portion 60A coupling the output rotational body 46 and the first carrier 82. The first transmission input portion 68A includes, for example, the first carrier 82.

The first carrier 82 includes, for example, a first carrier pin rotatably supporting the first planet gear 76. The first carrier pin can use a bearing to rotatably support the first planet gear 76. One end of the first carrier pin in the axial direction AX is, for example, supported by the first carrier portion 82A. The other end of the first carrier pin in the axial direction AX is, for example, supported by the second carrier portion 82B.

The second transmission unit 70 includes, for example, multiple second planetary gear mechanisms 84. In an example, the second transmission ratios respectively correspond to the second planetary gear mechanisms 84.

The second transmission unit 70 includes, for example, a second planetary gear unit 86. The second planetary gear unit 86 includes, for example, a second planet gear 88, a second sun gear 90 meshed with the second planet gear 88, and a second ring gear 92 meshed with the second planet gear 88.

The second planet gear 88 is, for example, one of multiple second planet gears 88. The second planet gears 88 are, for example, arranged about the transmission center axis C2 of the shaft member 64 and are spaced apart from each other. The number of the second planet gears 88 is, for example, 2 or greater and 8 or less. The number of the second planet gears 88 is, for example, 4.

The second planet gears 88 include, for example, a third transmission planet gear 88A and a fourth transmission planet gear 88B having a smaller pitch circle diameter than the third transmission planet gear 88A. The third transmission planet gear 88A and the fourth transmission planet gear 88B are, for example, formed integrally. Alternatively, the third transmission planet gear 88A and the fourth transmission planet gear 88B can be formed separately and configured to rotate integrally with each other.

The second sun gear 90 can be one of multiple second sun gears 90. The second sun gear 90, for example, meshes with the fourth transmission planet gear 88B. The rotational center axis of the second sun gear 90 is substantially the same as the transmission center axis C2 of the shaft member 64.

The second ring gear 92 includes, for example, a third transmission ring gear 92A. The second ring gear 92, for example, meshes with the third transmission planet gear 88A. The second ring gear 92 can be one of multiple second ring gears 92. In this case, the second ring gears 92 are, for example, rotatable independently from each other.

The second planetary gear unit 86 includes, for example, a second carrier 94 supporting the second planet gear 88. The second carrier 94 includes, for example, a third carrier portion 94A and a fourth carrier portion 94B.

The second carrier 94 includes, for example, a second carrier pin rotatably supporting the second planet gear 88. The second carrier pin can use a bearing to rotatably support the second planet gear 88. One end of the second carrier pin in the axial direction AX is, for example, supported by the third carrier portion 94A. The other end of the second carrier pin in the axial direction AX is, for example, supported by the fourth carrier portion 94B.

The first transmission unit 68 further includes, for example, a third planetary gear unit 96. The first planetary gear mechanism 72 includes, for example, the third planetary gear unit 96. The third planetary gear unit 96 includes, for example, a third planet gear 98, a third sun gear 100 meshed with the third planet gear 98, and a third ring gear 102 meshed with the third planet gear 98.

The third planet gear 98 is, for example, one of multiple third planet gears 98. The third planet gears 98 are, for example, arranged about the transmission center axis C2 of the shaft member 64 and are spaced apart from each other. The number of the third planet gears 98 is, for example, 2 or greater and 8 or less. The number of the third planet gears 98 is, for example, 4.

The third planet gear 98 includes, for example, a fifth transmission planet gear 98A and a sixth transmission planet gear 98B having a larger pitch circle diameter than the fifth transmission planet gear 98A. The fifth transmission planet gear 98A and the sixth transmission planet gear 98B are, for example, formed integrally. The fifth transmission planet gear 98A and the sixth transmission planet gear 98B can be formed separately and configured to rotate integrally with each other.

The third sun gear 100 can be one of multiple third sun gears 100. The third sun gear 100, for example, meshes with the fifth transmission planet gear 98A. The rotational center axis of the third sun gear 100 is substantially the same as the transmission center axis C2 of the shaft member 64.

The first sun gear 78 and the third sun gear 100 are, for example, formed integrally. The first sun gear 78 and the third sun gear 100 can be formed separately and configured to rotate integrally with each other. The first sun gear 78 has, for example, a smaller pitch circle diameter than the third sun gear 100.

The first sun gear 78 and the third sun gear 100 are, for example, formed separately from the shaft member 64 and configured to rotate integrally with the shaft member 64. The first sun gear 78 and the third sun gear 100 are, for example, formed on the outer circumference of a first tubular member 104A. In an example, a first engagement portion 104B is formed on the inner circumference of the first tubular member 104A. The first engagement portion 104B includes, for example, splines or serrations. The first engagement portion 104B engages, for example, a first shaft engagement portion 64A of the shaft member 64. The first shaft engagement portion 64A includes, for example, splines or serrations. The first shaft engagement portion 64A is, for example, formed integrally with the shaft member 64. The first sun gear 78 and the third sun gear 100 can be formed integrally with the shaft member 64.

The third ring gear 102 is, for example, one of multiple third ring gears 102. The third ring gears 102 are, for example, rotatable independently from each other. The third ring gears 102 include, for example, a fourth transmission ring gear 102A and a fifth transmission ring gear 102B. The fourth transmission ring gear 102A, for example, meshes with the fifth transmission planet gear 98A. The fifth transmission ring gear 102B, for example, meshes with the sixth transmission planet gear 98B.

The third planetary gear unit 96 includes, for example, a third carrier 106 supporting the third planet gear 98. The third carrier 106 includes, for example, a first carrier portion 82A and a second carrier portion 82B.

The third carrier 106 includes, for example, a third carrier pin rotatably supporting the third planet gear 98. The third carrier pin can rotatably support the third planet gear 98 using a bearing. One end of the third carrier pin in the axial direction AX is, for example, supported by the first carrier portion 82A. The other end of the third carrier pin in the axial direction AX is, for example, supported by the second carrier portion 82B.

Part of the first carrier 82 is, for example, formed integrally with part of the third carrier 106. The first carrier portion 82A is, for example, part of the first carrier 82 and part of the third carrier 106. The second carrier portion 82B is, for example, part of the first carrier 82 and part of the third carrier 106.

The second transmission unit 70 further includes, for example, a fourth planetary gear unit 108. The fourth planetary gear unit 108 includes, for example, a fourth planet gear 110, a fourth sun gear 112 meshed with the fourth planet gear 110, and a fourth ring gear 114 meshed with the fourth planet gear 110.

The fourth planet gear 110 is, for example, one of multiple fourth planet gears 110. The fourth planet gears 110 are, for example, arranged about the transmission center axis C2 of the shaft member 64 and spaced apart from each other. The number of the fourth planet gears 110 is, for example, 2 or greater and 8 or less. The number of the fourth planet gears 110 is, for example, 4. The fourth planet gears 110 include, for example, a seventh transmission planet gear 110A.

The fourth sun gear 112 can be one of multiple fourth sun gears 112. The fourth sun gear 112, for example, meshes with the fourth planet gear 110. The rotational center axis of the fourth sun gear 112 is substantially the same as the transmission center axis C2 of the shaft member 64.

The second sun gear 90 and the fourth sun gear 112 are, for example, formed integrally. The second sun gear 90 and the fourth sun gear 112 can be formed separately and configured to rotate integrally with each other.

The second sun gear 90 and the fourth sun gear 112 are, for example, formed separately from the shaft member 64 and configured to rotate integrally with the shaft member 64. The second sun gear 90 and the fourth sun gear 112 are, for example, formed on the outer circumference of a second tubular member 104C. For example, a second engagement portion 104D is formed on the inner circumference of the second tubular member 104C. The second engagement portion 104D includes, for example, splines or serrations. The second engagement portion 104D engages, for example, a second shaft engagement portion 64B of the shaft member 64. The second shaft engagement portion 64B includes, for example, splines or serrations. The second shaft engagement portion 64B is, for example, formed integrally with the shaft member 64. The second sun gear 90 and the fourth sun gear 112 can be formed integrally with, for example, the shaft member 64.

The fourth ring gear 114 includes, for example, a sixth transmission ring gear 114A. The fourth ring gear 114, for example, meshes with the fourth planet gear 110. The fourth ring gear 114 can be one of multiple fourth ring gears 114. In this case, the fourth ring gears 114 are, for example, rotatable independently from each other.

The fourth planetary gear unit 108 includes, for example, a fourth carrier 116 supporting the fourth planet gear 110. The fourth carrier 116 includes, for example, a third carrier portion 94A and a fourth carrier portion 94B.

The fourth carrier 116 includes, for example, a fourth carrier pin rotatably supporting the fourth planet gear 110. The fourth carrier pin can use a bearing to rotatably support the fourth planet gear 110. One end of the fourth carrier pin in the axial direction AX is, for example, supported by the third carrier portion 94A. The other end of the fourth carrier pin in the axial direction AX is, for example, supported by the fourth carrier portion 94B.

The second transmission unit 70 further includes, for example, a fifth planetary gear unit 118. The fifth planetary gear unit 118 includes, for example, a fifth planet gear 120, a fifth carrier 122 supporting the fifth planet gear 120, a fifth sun gear 124 engaging the fifth planet gear 120, and a fifth ring gear 126 meshing with the fifth planet gear 120.

The fifth planet gear 120 is, for example, one of multiple fifth planet gears 120. The fifth planet gears 120 are, for example, arranged about the transmission center axis C2 of the shaft member 64 and spaced apart from each other. The number of the fifth planet gears 120 is, for example, 2 or greater and 8 or less. The number of the fifth planet gears 120 is, for example, 4.

The fifth planet gear 120 includes, for example, an eighth transmission planet gear 120A and a ninth transmission planet gear 120B having a larger pitch circle diameter than the eighth transmission planet gear 120A. The eighth transmission planet gear 120A and the ninth transmission planet gear 120B are, for example, formed integrally. Alternatively, the eighth transmission planet gear 120A and the ninth transmission planet gear 120B can be formed separately and configured to rotate integrally with each other.

The fifth sun gear 124 can be one of multiple fifth sun gears 124. The fifth sun gear 124, for example, meshes with the ninth transmission planet gear 120B. The rotational center axis of the fifth sun gear 124 is substantially the same as the transmission center axis C2 of the shaft member 64.

The fifth sun gear 124 is, for example, formed integrally with the shaft member 64. The fifth sun gear 124 can be formed separately from the shaft member 64 and configured to rotate integrally with the shaft member 64 using splines or serrations.

The first sun gear 78, the second sun gear 90, the third sun gear 100, the fourth sun gear 112, and the fifth sun gear 124 are, for example, configured to rotate integrally with one another about the transmission center axis C2 of the shaft member 64 in the clockwise direction as viewed in the output rotational body 46. The first sun gear 78, the second sun gear 90, the third sun gear 100, the fourth sun gear 112, and the fifth sun gear 124 can be, for example, configured to rotate integrally with one another about the transmission center axis C2 of the shaft member 64 in the counterclockwise direction as viewed in the output rotational body 46.

The first sun gear 78 has, for example, a larger pitch circle diameter than the fifth sun gear 124. The first sun gear 78 has, for example, a smaller pitch circle diameter than each of the second sun gear 90, the third sun gear 100, and the fourth sun gear 112.

The second sun gear 90 has, for example, a larger pitch circle diameter than each of the first sun gear 78 and the fifth sun gear 124. The second sun gear 90 has, for example, a smaller pitch circle diameter than each of the third sun gear 100 and the fourth sun gear 112.

The third sun gear 100 has, for example, a larger pitch circle diameter than each of the first sun gear 78, the second sun gear 90, the fourth sun gear 112, and the fifth sun gear 124.

The fourth sun gear 112 has, for example, a larger pitch circle diameter than each of the first sun gear 78, the second sun gear 90, and the fifth sun gear 124. The fourth sun gear 112 has, for example, a smaller pitch circle diameter than the third sun gear 100.

The fifth sun gear 124 has, for example, a smaller pitch circle diameter than each of the first sun gear 78, the second sun gear 90, the third sun gear 100, and the fourth sun gear 112.

The fifth ring gear 126 includes, for example, a seventh transmission ring gear 126A. The fifth ring gear 126, for example, meshes with the eighth transmission planet gear 120A. The fifth ring gear 126 can be one of multiple fifth ring gears 126. In this case, the fifth ring gears 126 are, for example, rotatable independently from each other.

Part of the fifth carrier 122 is, for example, formed integrally with part of the second carrier 94. Part of the fifth carrier 122 is, for example, formed integrally with part of the fourth carrier 116. The second transmission output portion 70B includes, for example, a fifth carrier 122.

The fifth carrier 122 includes, for example, a fifth carrier pin rotatably supporting the fifth planet gear 120. The fifth carrier 122 includes, for example, the third carrier portion 94A, the fourth carrier portion 94B, and a fifth carrier portion 128. The fifth carrier pin is, for example, supported by the third carrier portion 94A, the fourth carrier portion 94B, and the fifth carrier portion 128. One end of the fifth carrier pin in the axial direction AX is, for example, supported by the third carrier portion 94A. The other one end of the fifth carrier pin in the axial direction AX is, for example, supported by the fifth carrier portion 128. The fourth carrier portion 94B is, for example, arranged between the third carrier portion 94A and the fifth carrier portion 128. The fourth carrier portion 94B supports, for example, a portion of the fifth carrier pin between the third carrier portion 94A and the fifth carrier portion 128.

In the first planetary gear unit 74, for example, the rotational state of one of the first sun gear 78, the first carrier 82, and the first ring gear 80 is controlled to select one of the first transmission ratios. In the third planetary gear unit 96, for example, the rotational state of one of the third sun gear 100, the third carrier 106, and the third ring gear 102 is controlled to select one of the first transmission ratios.

In the second planetary gear unit 86, for example, the rotational state of one of the second sun gear 90, the second carrier 94, and the second ring gear 92 is controlled to select one of the second transmission ratios. In the fourth planetary gear unit 108, for example, the rotational state of one of the fourth sun gear 112, the fourth carrier 116, and the fourth ring gear 114 is controlled to select one of the second transmission ratios. In the fifth planetary gear unit 118, for example, the rotational state of one of the fifth sun gear 124, the fifth carrier 122, and the fifth ring gear 126 is controlled to select one of the second transmission ratios.

In the first transmission unit 68, for example, the rotational state of one of the first ring gear 80 and the third ring gear 102 is controlled to select one of the first transmission ratios. In the second transmission unit 70, for example, the rotational state of one of the second ring gear 92, the fourth ring gear 114, and the fifth ring gear 126 is controlled to select one of the second transmission ratios. In the transmission unit 34, for example, the rotational state of one of the first ring gear 80, the second ring gear 92, the third ring gear 102, the fourth ring gear 114, and the fifth ring gear 126 is controlled to select one of the second transmission ratios.

The transmission unit 34 has, for example, multiple transmission paths. The transmission paths form part of the transmission path of human driving force. Rotational force that is input from the rotation ratio shifting unit 32 to the transmission input portion 60 is output to the output 36 through one of the transmission paths. The transmission paths include a first transmission path, a second transmission path, a third transmission path, a fourth transmission path, a fifth transmission path, a sixth transmission path, a seventh transmission path, an eighth transmission path, a ninth transmission path, a tenth transmission path, an eleventh transmission path, and a twelfth transmission path.

The first transmission path is, for example, a transmission path in which driving force input to the first transmission input portion 68A is transmitted through the third carrier 106, the sixth transmission planet gear 98B, the third sun gear 100, the shaft member 64, the fifth sun gear 124, the ninth transmission planet gear 120B, and the fifth carrier portion 128 to the output 36.

The second transmission path is, for example, a transmission path in which driving force input to the first transmission input portion 68A is transmitted through the third carrier 106, the fifth transmission planet gear 98A, the third sun gear 100, the shaft member 64, the fifth sun gear 124, the ninth transmission planet gear 120B, and the fifth carrier portion 128 to the output 36.

The third transmission path is, for example, a transmission path in which driving force input to the first transmission input portion 68A is transmitted through the first carrier 82, the second transmission planet gear 76B, the first sun gear 78, the shaft member 64, the fifth sun gear 124, the ninth transmission planet gear 120B, and the fifth carrier portion 128 to the output 36.

The fourth transmission path is, for example, a transmission path in which driving force input to the first transmission input portion 68A is transmitted through the first carrier 82, the first transmission planet gear 76A, the second transmission planet gear 76B, the first sun gear 78, the shaft member 64, the fifth sun gear 124, the ninth transmission planet gear 120B, and the fifth carrier portion 128 to the output 36.

The fifth transmission path is, for example, a transmission path in which driving force input to the first transmission input portion 68A is transmitted through the third carrier 106, the sixth transmission planet gear 98B, the third sun gear 100, the shaft member 64, the fourth sun gear 112, the fourth planet gear 110, the fourth carrier portion 94B, and the fifth carrier portion 128 to the output 36.

The sixth transmission path is, for example, a transmission path in which driving force input to the first transmission input portion 68A is transmitted through the third carrier 106, the fifth transmission planet gear 98A, the third sun gear 100, the shaft member 64, the fourth sun gear 112, the fourth planet gear 110, the fourth carrier portion 94B, and the fifth carrier portion 128 to the output 36.

The seventh transmission path is, for example, a transmission path in which driving force input to the first transmission input portion 68A is transmitted through the first carrier 82, the second transmission planet gear 76B, the first sun gear 78, the shaft member 64, the fourth sun gear 112, the fourth planet gear 110, the fourth carrier portion 94B, and the fifth carrier portion 128 to the output 36.

The eighth transmission path is, for example, a transmission path in which driving force input to the first transmission input portion 68A is transmitted through the first carrier 82, the first transmission planet gear 76A, the second transmission planet gear 76B, the first sun gear 78, the shaft member 64, the fourth sun gear 112, the fourth planet gear 110, the fourth carrier portion 94B, and the fifth carrier portion 128 to the output 36.

The ninth transmission path is, for example, a transmission path in which driving force input to the first transmission input portion 68A is transmitted through the third carrier 106, the sixth transmission planet gear 98B, the third sun gear 100, the shaft member 64, the second sun gear 90, the fourth transmission planet gear 88B, the fourth carrier portion 94B, and the fifth carrier portion 128 to the output 36.

The tenth transmission path is, for example, a transmission path in which driving force input to the first transmission input portion 68A is transmitted through the third carrier 106, the fifth transmission planet gear 98A, the third sun gear 100, the shaft member 64, the second sun gear 90, the fourth transmission planet gear 88B, the fourth carrier portion 94B, and the fifth carrier portion 128 to the output 36.

The eleventh transmission path is, for example, a transmission path in which driving force input to the first transmission input portion 68A is transmitted through the first carrier 82, the second transmission planet gear 76B, the first sun gear 78, the shaft member 64, the second sun gear 90, the fourth transmission planet gear 88B, the fourth carrier portion 94B, and the fifth carrier portion 128 to the output 36.

The twelfth transmission path is, for example, a transmission path in which driving force input to the first transmission input portion 68A is transmitted through the first carrier 82, the first transmission planet gear 76A, the second transmission planet gear 76B, the first sun gear 78, the shaft member 64, the second sun gear 90, the fourth transmission planet gear 88B, the fourth carrier portion 94B, and the fifth carrier portion 128 to the output 36.

The first to twelfth transmission paths are, for example, selected in accordance with the rotational states of the transmission ring gears 80A, 80B, 92A, 102A, 102B, 114A, and 126A. The rotational states of the transmission ring gears 80A, 80B, 92A, 102A, 102B, 114A, and 126A are switched, for example, between a permission state and a restriction state. In the restriction state, rotation of the transmission ring gears 80A, 80B, 92A, 102A, 102B, 114A, and 126A relative to the housing 22 is restricted. In the permission state, rotation of the transmission ring gears 80A, 80B, 92A, 102A, 102B, 114A, and 126A relative to the housing 22 is permitted. In the restriction state, as viewed from the output rotational body 46 about the transmission center axis C2 of the shaft member 64, as long as rotation in one of the clockwise direction and the counterclockwise direction is restricted to hinder rotation of the transmission ring gears 80A, 80B, 92A, 102A, 102B, 114A, and 126A so that the transmission unit 34 transmits human driving force, rotation in the other direction can be permitted.

Table 1 shows the rotational states of the transmission ring gears 80A, 80B, 92A, 102A, 102B, 114A, and 126A that are included in the first transmission unit 68 and the rotational states of the transmission ring gears 80A, 80B, 92A, 102A, 102B, 114A, and 126A that are included in the second transmission unit 70 in each of the transmission paths. The transmission ring gears 80A, 80B, 92A, 102A, 102B, 114A, and 126A in the first transmission unit 68 include, for example, the first transmission ring gear 80A, the second transmission ring gear 80B, the fourth transmission ring gear 102A, and the fifth transmission ring gear 102B. The transmission ring gears 80A, 80B, 92A, 102A, 102B, 114A, and 126A in the second transmission unit 70 include, for example, the third transmission ring gear 92A, the sixth transmission ring gear 114A, and the seventh transmission ring gear 126A. In Table 1, “o” indicates that the rotational state of the first transmission ring gear 80A, the second transmission ring gear 80B, the third transmission ring gear 92A, the fourth transmission ring gear 102A, the fifth transmission ring gear 102B, the sixth transmission ring gear 114A, and the seventh transmission ring gear 126A is the restriction state. In Table 1, “x” indicates the rotational state of the first transmission ring gear 80A, the second transmission ring gear 80B, the third transmission ring gear 92A, the fourth transmission ring gear 102A, the fifth transmission ring gear 102B, the sixth transmission ring gear 114A, and the seventh transmission ring gear 126A is the permission state.

TABLE 1

| | 1st Transmission Unit | | | | 2nd Transmission Unit | | |
|---|---|---|---|---|---|---|---|
| | 1st | 2nd | 4th | 5th | 3rd | 6th | 7th |
| Transmission | Transmission | Transmission | Transmission | Transmission | Transmission | Transmission | Transmission |
| Path | Ring Gear | Ring Gear | Ring Gear | Ring Gear | Ring Gear | Ring Gear | Ring Gear |
| 1 | x | x | x | ∘ | x | x | ∘ |
| 2 | x | x | ∘ | x | x | x | ∘ |
| 3 | x | ∘ | x | x | x | x | ∘ |
| 4 | ∘ | x | x | x | x | x | ∘ |
| 5 | x | x | x | ∘ | x | ∘ | x |
| 6 | x | x | ∘ | x | x | ∘ | x |
| 7 | x | ∘ | x | x | x | ∘ | x |
| 8 | ∘ | x | x | x | x | ∘ | x |
| 9 | x | x | x | ∘ | ∘ | x | x |
| 10 | x | x | ∘ | x | ∘ | x | x |
| 11 | x | ∘ | x | x | ∘ | x | x |
| 12 | ∘ | x | x | x | ∘ | x | x |

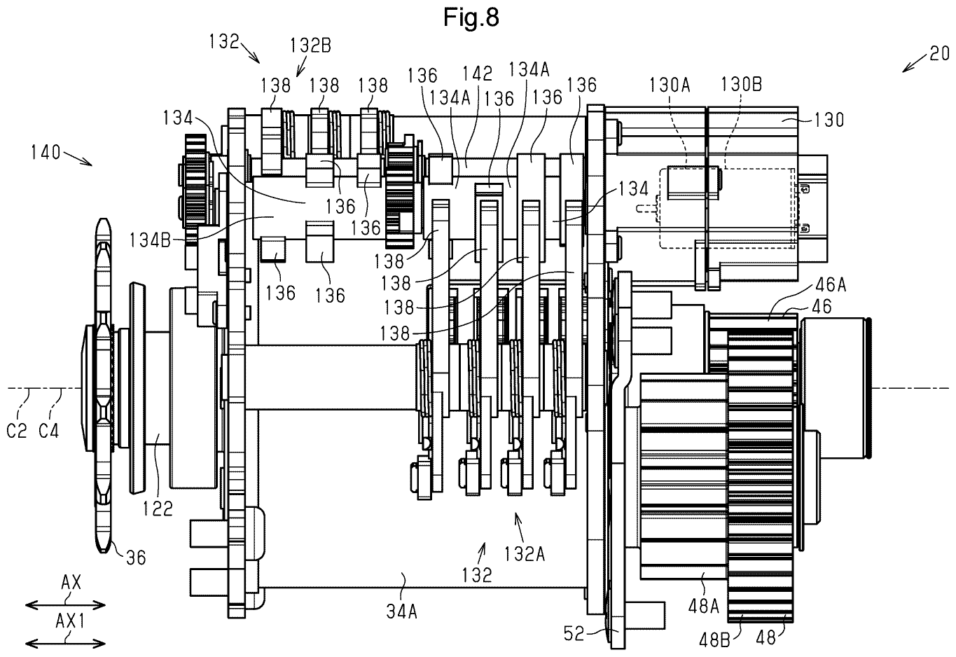

As shown in FIGS. 8 and 12, a rotation controller 132 selects the restriction state and the permission state of each of the transmission ring gears 80A, 80B, 92A, 102A, 102B, 114A, and 126A. Each of the transmission ring gears 80A, 80B, 92A, 102A, 102B, 114A, and 126A includes, for example, an engaged portion. The engaged portion is, for example, provided on the outer circumference of the transmission ring gears 80A, 80B, 92A, 102A, 102B, 114A, and 126A.

As shown in FIG. 7, the component 20 further includes, for example, a transmission controller 130 controlling the transmission unit 34. The transmission controller 130 is, for example, provided in the second housing 30. At least part of the transmission controller 130 is, for example, arranged in a space defined by an inner surface of the second housing 30. Part of the transmission controller 130 is, for example, arranged in a space defined by an inner surface of the first housing 28. The entirety of the transmission controller 130 can be arranged in the space defined by the inner surface of the second housing 30.

As shown in FIGS. 8 and 12, for example, the transmission controller 130 is configured to control the rotational state of the first ring gear 80 and the rotational state of the second ring gear 92. The transmission controller 130 is, for example, configured to control the rotational state of the third ring gear 102, the rotational state of the fourth ring gear 114, and the rotational state of the fifth ring gear 126.

The transmission controller 130 includes a driver 130A. The transmission controller 130 controls the transmission unit 34 to shift the transmission ratio. The driver 130A includes, for example, an electric motor 130B. The transmission controller 130 further includes, for example, a speed reducer connected to the electric motor 130B.

The transmission controller 130 includes, for example, a rotation controller 132 controlling the transmission unit 34. The rotation controller 132 includes, for example, a camshaft 134, cams 136, and control members 138. The control members 138 are, for example, provided for each of the transmission ring gears 80A, 80B, 92A, 102A, 102B, 114A, and 126A. The control members 138 move, for example, between the cams 136 and the transmission ring gears 80A, 80B, 92A, 102A, 102B, 114A, and 126A. For example, the control members 138 control the rotational states of the transmission ring gears 80A, 80B, 92A, 102A, 102B, 114A, and 126A to select one from different transmission ratios. The control members 138 each include, for example, an engagement portion engaging the engaged portion.

The rotation controller 132 restricts rotation of the transmission ring gears 80A, 80B, 92A, 102A, 102B, 114A, and 126A by, for example, engaging the engagement portions of the control members 138 with the engaged portions of the transmission ring gears 80A, 80B, 92A, 102A, 102B, 114A, and 126A. Thus, the transmission ring gears 80A, 80B, 92A, 102A, 102B, 114A, and 126A are in the restriction state. The rotation controller 132 allows for rotation of the transmission ring gears 80A, 80B, 92A, 102A, 102B, 114A, and 126A by, for example, disengaging the engagement portions of the control members 138 from the engaged portions of the transmission ring gears 80A, 80B, 92A, 102A, 102B, 114A, and 126A. Thus, the transmission ring gears 80A, 80B, 92A, 102A, 102B, 114A, and 126A are in the permission state.

The rotation controller 132, for example, switches the rotational states of the transmission ring gears 80A, 80B, 92A, 102A, 102B, 114A, and 126A between the permission state and the restriction state to switch from one of the transmission paths to another one of the transmission paths.

The rotation controller 132 includes, for example, a first rotation controller 132A corresponding to the first transmission unit 68. The first rotation controller 132A includes, for example, the first camshaft 134A and controls the first transmission unit 68. The first rotation controller 132A is, for example, configured to select one of the first transmission ratios of the first transmission unit 68 by controlling the rotational states of the first ring gear 80 and the third ring gear 102 in accordance with rotation of the first camshaft 134A.

The rotation controller 132 includes, for example, a second rotation controller 132B corresponding to the second transmission unit 70. The second rotation controller 132B is, for example, configured to select one from the second transmission ratios of the second transmission unit 70 by controlling the control states of the second ring gear 92, the fourth ring gear 114, and the fifth ring gear 126 in accordance with rotation of the second camshaft 134B.

The transmission controller 130 includes, for example, an interlock mechanism 140. The transmission controller 130 includes, for example, a drive shaft 142 rotating the first camshaft 134A and the second camshaft 134B using the interlock mechanism 140. The interlock mechanism 140 interlocks, for example, the first camshaft 134A and the second camshaft 134B. The drive shaft 142 extends, for example, parallel to the first camshaft 134A and the second camshaft 134B.

The interlock mechanism 140 is, for example, configured to interlock the first camshaft 134A and the second camshaft 134B to restrict rotation of any one of the first ring gear 80, the second ring gear 92, the third ring gear 102, the fourth ring gear 114, and the fifth ring gear 126 regardless of the rotational phase of the drive shaft 142.

The driver 130A is, for example, connected to the drive shaft 142 via the speed reducer. The electric motor 130B of the driver 130A is driven to rotate the drive shaft 142. The driver 130A rotates the drive shaft 142 to, for example, switch the rotational states of the transmission ring gears 80A, 80B, 92A, 102A, 102B, 114A, and 126A between the restriction state and the permission state and to select one from the transmission paths. For example, the driver 130A switches the rotational states of the transmission ring gears 80A, 80B, 92A, 102A, 102B, 114A, and 126A between the restriction state and the permission state and select one from the first to twelfth transmission paths while the drive shaft 142 is undergoing three rotations.

The driver 130A can further include a transmission control circuit controlling the electric motor 130B. The transmission control circuit can include an inverter circuit controlling the electric motor 130B. The transmission control circuit includes, for example, a transmission control device. The transmission control device is, for example, provided on one or more circuit substrates. The transmission control device is, for example, configured to control the driver 130A. The transmission control device includes, for example, a processor that executes a predetermined control program. The processor includes, for example, a central processing unit (CPU) or a micro-processing unit (MPU). The processor can be provided at separate locations. The transmission control device can include one or more microcomputers.

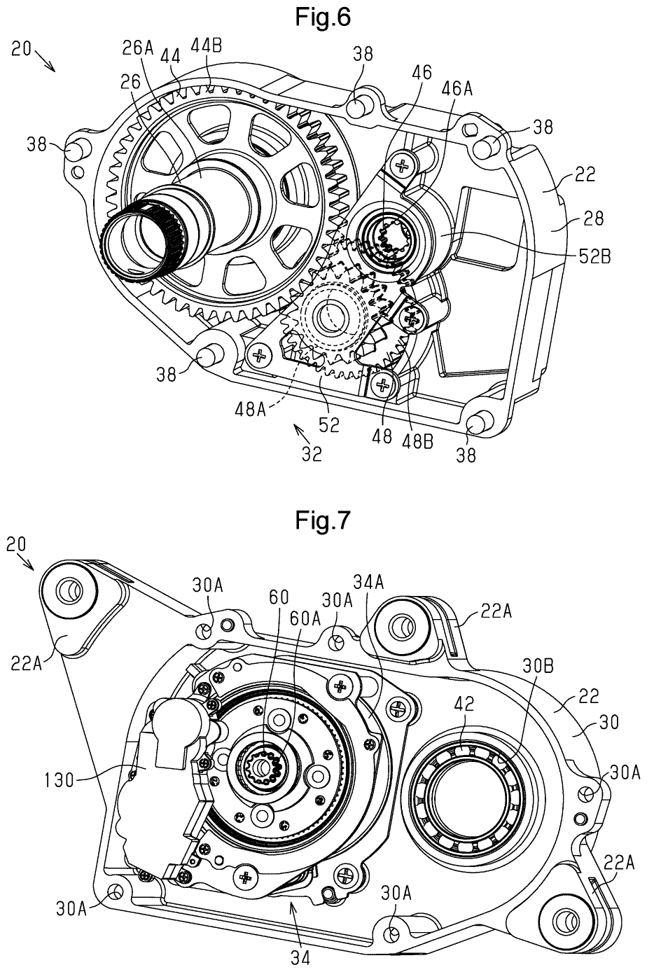

As shown in FIG. 6, at least part of the rotation ratio shifting unit 32 is, for example, provided in the first housing 28 in a manner independent from the second housing 30. The rotation ratio shifting unit 32 is, for example, supported by only the first housing 28. Members that are supported by the first housing 28 include, for example, the rotation ratio shifting unit 32, the support 52, the input shaft 26. The input shaft 26 is, for example, supported by the first housing 28 and the second housing 30.

As shown in FIG. 7, at least part of the transmission unit 34 is, for example, provided in the second housing 30 in a manner independent from the first housing 28. The transmission unit 34 is, for example, supported by only the second housing 30. The transmission controller 130 is, for example, provided in the second housing 30 in a manner independent from the first housing 28. The transmission unit 34 is, for example, supported by only the second housing 30. Members that are supported by the second housing 30 include, for example, the transmission unit 34, the transmission controller 130, the output 36, and the input shaft 26.

In an example, the first housing 28 is coupled to the second housing 30 to manufacture the component 20. In a case where the first housing 28 is coupled to the second housing 30, multiple members are provided in each of the first housing 28 and the second housing 30 in advance. At least one of members is configured to be provided in one of the first housing 28 and the second housing 30 before the coupling of the first housing 28 to the second housing 30 and configured not to be supported by the other of the first housing 28 and the second housing 30 after the coupling of the first housing 28 to the second housing 30.

As shown in FIG. 6, in an example, before the first housing 28 is coupled to the second housing 30, at least part of the rotation ratio shifting unit 32 is provided in the first housing 28. In an example, before the first housing 28 is coupled to the second housing 30, the entirety of the rotation ratio shifting unit 32 is provided in the first housing 28. The linking rotational body 48 and the linking rotational shaft 50 are provided in the first housing 28 and are, for example, sandwiched between the first housing 28 and the support 52. The output rotational body 46 is provided in the first housing 28 and is, for example, sandwiched between the first housing 28 and the support 52.

As shown in FIG. 7, before the first housing 28 is coupled to the second housing 30, at least part of the transmission unit 34 is provided in the second housing 30. Before the first housing 28 is coupled to the second housing 30, the entirety of the transmission unit 34 is provided in the second housing 30.

### Modified Examples

The description related with the above embodiment exemplifies, without any intention to limit, applicable forms of the component 20 according to the present disclosure. The component 20 according to the present disclosure is applicable to, for example, modified examples of the above embodiment that are described below and combinations of at least two of the modified examples that are consistent with each other. In the following modified examples, same reference characters are given to those components that are the same as the corresponding components of the above embodiments. Such components will not be described in detail.

As shown in FIG. 14, as viewed in the input axial direction AX1, the rotation ratio shifting unit 32 can be configured so that the linking center axis C3 is located on a line connecting the input center axis C1 and the output center axis C4. As in the component 20 shown in FIG. 5, as viewed in the input axial direction AX1, in a case where the linking center axis C3 is not located on the line connecting the input center axis C1 and the output center axis C4, the size of the component 20 is reduced in a direction extending along the line connecting the input center axis C1 and the output center axis C4. The component 20 shown in FIG. 14 is reduced in size in a direction orthogonal to the direction extending along the line connecting the input center axis C1 and the output center axis C4.

The input rotational body 44 can overlap the output rotational body 46 as viewed in the input axial direction AX1 aligned with the input center axis C1.

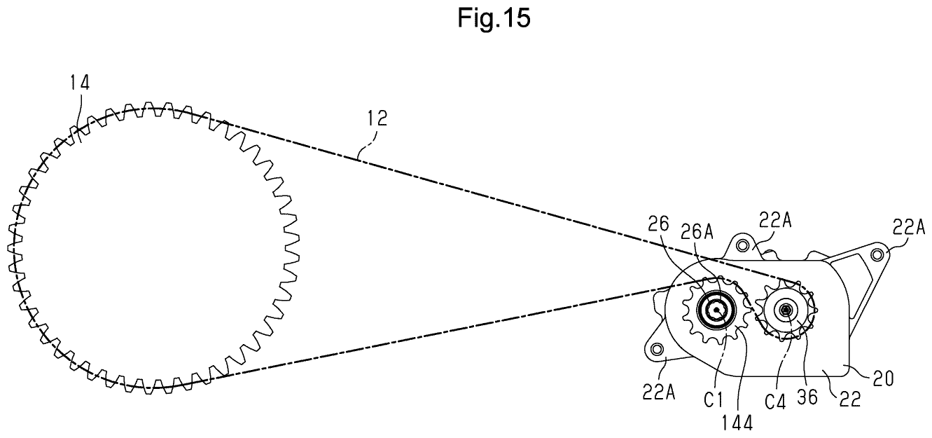

As shown in FIG. 15, the component 20 can further include an auxiliary rotational body 144. The auxiliary rotational body 144 is, for example, coupled to the input shaft 26. The auxiliary rotational body 144 is, for example, configured to rotate relative to the input shaft 26 about the input center axis C1. The auxiliary rotational body 144 rotates, for example, independently from the input shaft 26. The auxiliary rotational body 144 is, for example, a pulley. The auxiliary rotational body 144 is, for example, configured to engage the linking body 12.

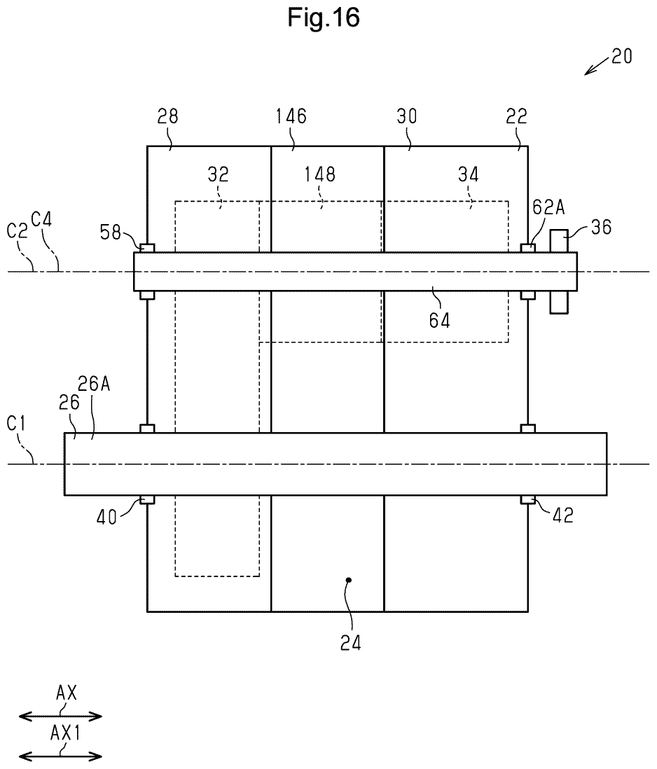

As shown in FIG. 16, the component 20 can further include a third housing 146 and an intermediate linking portion 148. At least part of the intermediate linking portion 148 is, for example, provided in the third housing 146. In this modified example, the second housing 30 is, for example, coupled to the first housing 28 by the third housing 146. In an example, rotational force of the rotation ratio shifting unit 32 is transmitted to the intermediate linking portion 148. In an example, the intermediate linking portion 148 transmits rotational force to the transmission unit 34. The intermediate linking portion 148 can include, but does not necessarily have to include, a speed increaser or a speed reducer.

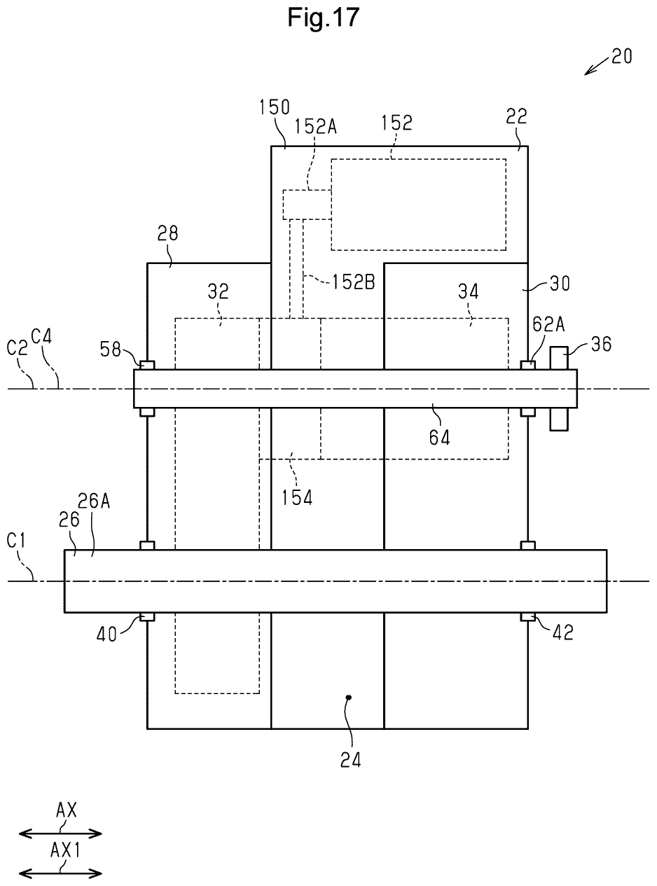

As shown in FIG. 17, the component 20 can further include a fourth housing 150 and a motor 152. The motor 152 is, for example, configured to apply propulsion force to the human-powered vehicle. The motor 152 is, for example, an assist motor. At least part of the motor 152 is, for example, provided in the fourth housing 150. The second housing 30 is, for example, coupled to the first housing 28 by the fourth housing 150. The motor 152 includes, for example, a motor rotation shaft 152A. The motor rotation shaft 152A is, for example, spaced apart from the shaft member 64. The component 20 further includes, for example, a resultant force portion 154. In this modified example, as long as the motor 152 is configured to input rotational force of the motor 152 to the transmission path of human driving force, the motor 152 can be connected to any member included in the transmission path of human driving force. In this modified example, for example, the rotational force of the motor 152 is transmitted to the resultant force portion 154 provided in the second housing 30. The component 20 further includes, for example, a motor speed reducer 152B. The rotational force of the motor 152 is, for example, transmitted to the resultant force portion 154 through the motor rotation shaft 152A and the motor speed reducer 152B. The resultant force portion 154 can be provided on the transmission unit 34.

The component 20 can have multiple linking center axes C3. In an example, the number of linking center axes C3 is odd. In an example, in a case where the number of linking center axes C3 is even, the rotation ratio shifting unit 32 can further include a predetermined planetary gear mechanism between the output rotational body 46 and the transmission unit 34. The predetermined planetary gear mechanism is configured such that, for example, a direction of rotation that is input to the predetermined planetary gear mechanism is opposite to a direction of rotation that is output from the predetermined planetary gear mechanism.

The input rotational body 44, the output rotational body 46, and the linking rotational body 48 can include at least one of a pulley and a chain instead of a gear.

The number of teeth of the first linking gear 48A can be the same as the number of teeth of the second linking gear 48B or can be greater than the number of teeth of the second linking gear 48B.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Ordinal numerals such as “first”, “second”, and “third” are used in this disclosure only to distinguish members having the same name from one another and are not intended to have any special meaning.

What is claimed is:

1. A component for a human-powered vehicle, the component comprising:
an input shaft configured to have a human driving force input thereto and having an input center axis;
a rotation ratio shifting unit configured to have a rotational force of the input shaft transmitted thereto; and
a transmission unit including a transmission input portion configured to have a rotational force from the rotation ratio shifting unit input thereto, a transmission output portion configured to externally output the rotational force input to the transmission input portion, and a transmission center axis differing from the input center axis, the transmission unit being configured to shift a transmission ratio that is a ratio of a rotational speed of the transmission output portion to a rotational speed of the transmission input portion,
the rotation ratio shifting unit including
an input rotational body connected to the input shaft and rotated about the input center axis,
an output rotational body connected to the transmission unit and rotated about the transmission center axis, and
a linking rotational body configured to transmit a rotational force of the input rotational body to the output rotational body, and
the rotation ratio shifting unit being configured to shift a ratio of a rotational speed of the output rotational body to a rotational speed of the input rotational body,
the linking rotational body configured to be rotated about a linking center axis differing from both the input center axis and the transmission center axis.

2. The component according to claim 1, wherein
a final shifting ratio that is a ratio of the rotational speed of the output rotational body to the rotational speed of the input rotational body is greater than 1.0.

3. The component according to claim 2, wherein
the final shifting ratio is greater than 6.0.

4. The component according to claim 1, wherein
a first shifting ratio that is a ratio of a rotational speed of the linking rotational body to the rotational speed of the input rotational body is greater than 1.0.

5. The component according to claim 1, wherein
a second shifting ratio that is a ratio of the rotational speed of the output rotational body to a rotational speed of the linking rotational body is greater than 1.0.

6. The component according to claim 4, wherein
a second shifting ratio that is the ratio of a rotational speed of the output rotational body to a rotational speed of the linking rotational body is greater than 1, and
the first shifting ratio is greater than the second shifting ratio.

7. The component according to claim 1, wherein
the input rotational body includes an input gear,
the output rotational body includes an output gear, and
the linking rotational body includes a first linking gear configured to mesh with the input gear and a second linking gear configured to mesh with the output gear.

8. The component according to claim 7, wherein
the first linking gear is integrally formed with the second linking gear.

9. The component according to claim 7, wherein
the first linking gear and the second linking gear have differing numbers of teeth.

10. The component according to claim 1, wherein
the input rotational body is separated from the output rotational body as viewed in an input axial direction aligned with the input center axis.

11. The component according to claim 1, wherein
in a case where the input rotational body is rotated in one of a clockwise direction and a counterclockwise direction as viewed in an input axial direction aligned with the input center axis, the output rotational body is configured to be rotated in the one of the clockwise direction and the counterclockwise direction as viewed in the input axial direction.

12. The component according to claim 1, wherein
the transmission unit includes at least one planetary gear mechanism.

13. The component according to claim 1, wherein
the transmission unit further includes
a first transmission unit including a first transmission input portion configured to have a rotational force from the transmission input portion transmitted thereto, and a first transmission output portion configured to have a rotational force from the first transmission input portion transmitted thereto, and
a second transmission unit including a second transmission input portion configured to have a rotational force from the first transmission output portion transmitted thereto, and a second transmission output portion configured to have a rotational force from the second transmission input portion transmitted thereto;
the first transmission unit is configured to select a ratio of a rotational speed of the first transmission output portion to a rotational speed of the first transmission input portion from multiple first transmission ratios, and
the second transmission unit is configured to select a ratio of a rotational speed of the second transmission output portion to a rotational speed of the second transmission input portion from multiple second transmission ratios.

14. The component according to claim 13, wherein:
the first transmission unit includes a first planetary gear unit;
the first planetary gear unit includes
a first planet gear,
a first carrier supporting the first planet gear,
a first sun gear meshed with the first planet gear, and
a first ring gear meshed with the first planet gear;
a rotational state of at least one of the first sun gear, the first carrier, and the first ring gear being controlled to select one of the first transmission ratios;
the second transmission unit includes a second planetary gear unit;
the second planetary gear unit includes
a second planet gear,
a second carrier supporting the second planet gear,
a second sun gear meshed with the second planet gear, and
a second ring gear meshed with the second planet gear; and
a rotational state of at least one of the second sun gear, the second carrier, and the second ring gear being controlled to select one of the second transmission ratios.

15. The component according to claim 14, further comprising:
a transmission controller configured to control the transmission unit, and
the transmission controller being configured to control the rotational state of the first ring gear and the rotational state of the second ring gear.

16. The component according to claim 14, wherein
the output rotational body is configured to be connected to the transmission unit by a coupling portion coupling the output rotational body and the first carrier.

17. The component according to claim 1, wherein
the input shaft is a crank axle of the human-powered vehicle.

18. The component according to claim 1, further comprising:
an output configured to output a rotational force of the transmission output portion, and
the output having an output center axis differing from the input center axis.

19. The component according to claim 18, wherein
the output center axis is concentric with the transmission center axis.

20. The component according to claim 1, further comprising:
a housing including an interior space, and
the rotation ratio shifting unit and the transmission unit are arranged in the interior space.
